(19) United States
(12) Patent Application Publication
(10) Pub. No.: US 2008/0059523 A1
(43) Pub. Date: Mar. 6, 2008

(54) Systems and methods of matching requirements and standards in employment-related environments

(76) Inventors: Michael Aaron Schmidt, Riverside, CA (US); Barry R. Pulliam, San Antonio, TX (US); Marilyn Tompkins Gogolin, Irvine, CA (US); Julia Louise Maiz, Chino Hills, CA (US); James A. Kuhr, Sammamish, WA (US); Dena Michelle Smith, Riverside, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/512,506

(22) Filed: Aug. 29, 2006

(51) Int. Cl. G06F 17/00

(52) U.S. Cl. 707/104.1

(57) ABSTRACT

Systems and methods of matching employers to job applicants are provided. Job applicants provide self-assessment of their capabilities in certain abilities, skills, knowledge, and other employment-related attributes. Associates of the job applicants provide their assessment of the job applicant with respect to the same or substantially similar attributes. Employers post job positions specifying certain abilities, skills, and knowledge as being required or optional for job applicants for the position. Employers are matched with job applicants based on comparisons of the abilities, skills, and knowledge and other job attributes of the job applicants against the abilities, skills, and knowledge and other job attributes desired by the employers.

### BACKGROUND OF THE INVENTION

1. Field of the Invention

This application relates to computer implemented or computer-assisted systems and methods for workforce development. More particularly, the application discloses computer-implemented or computer-aided systems and methods for matching the needs of employers with attributes and performance standard of employees and job applicants.

2. Description of the Related Art

In recent years, employment-related services have been greatly enhanced through the use of software applications and the Internet. Career services websites such as Monster.COM® and Careerbuilder.COM® have enhanced the ability of employers to cast a wider net in searching for qualified candidates. For example, where an employer previously would need to advertise in many local newspapers to reach an audience in several cities, utilizing Internet-based job websites now enables the employer to place a single listing that is accessible from anywhere in the world. Career services websites such as these have also enhanced the ability of job seekers or candidates to identify potential job openings by allowing them the ability to search thousands of jobs quickly, and to build and post resumes that can be viewed online by potential employers.

Although these types of websites have improved the ability of job seekers to find job opportunities (and vice-versa), these types of career services websites suffer from various shortcomings. For example, due to their availability over the Internet, a single job listing may receive thousands of resumes seeking employment. Thus, it can be difficult for employers to sift through the large volume of job applications and identify those candidates that may be the best qualified. This problem of volume also affects potential candidates. When a candidate applies for a job for which he is perfectly suited, there is a danger that his resume may be overlooked during the review process due to the volume of resumes received by the employers. Additionally, job candidates often find that when they search for jobs, thousands of jobs may satisfy the broad parameters of their search. Thus, it becomes difficult to identify opportunities among the many hits which best align with the capabilities and qualifications of the job candidate.

Thus, what is needed are systems and methods that allow job applicants to distinguish themselves from other job applicants in a quantifiable way that is accessible to job providers. In addition, it would be useful to provide a way for employers to identify suitable candidates for an advertised position without having to review a large number of received applications.

### SUMMARY

The system, method, and devices of the invention each have several aspects, no single one of which is solely responsible for its desirable attributes. Without limiting the scope of this invention, several of its features will now be discussed briefly.

In one embodiment, a computer-implemented method of creating an online employment profile is provided. The method includes accessing a database to retrieve applicable attributes for a job type. The retrieved attributes may then be presented to the applicant for self-assessment. The applicant provides a self-assessment in the retrieved attributes. Information identifying one or more survey recipients may then be received. The information may include contact information for each of the survey recipients. A message may then be sent to the survey recipients which seeks a rating of the attributes of the applicant. In response to the message, the survey recipients may send their ratings of the job applicant. The received self-rating and survey recipient ratings are then stored in an employer accessible database.

In another embodiment, a computer-implemented method for matching a job applicant with an employer is provided. The method may include receiving input data from the job applicant, the input data including a self-assessment by the job applicant of the aptitude of the job applicant in certain job attributes. A message may then be sent to persons knowing the job applicant. The message may include a request for an assessment of the job applicant in at least one of the various attributes. Assessments of the job applicant may then be received from the survey recipients. Based on the received assessment, a rating for the job applicant in the certain attributes is created, and the applicant is matched to the employer based on the rating.

In another embodiment, a computer-implemented method of defining a job listing in a computer network is provided. The method may include receiving a selection of a job type and accessing a database to retrieve attributes for the selected job type. The method may further include presenting user selectable options for specifying whether the retrieved attributes are required or optional. The user may then select required attributes and optional attributes, and for each of the selected required attributes, the user may provide input indicative of a minimal desirable rating for the required attributes.

In yet another embodiment, a method of matching an employer offering a job position and a job applicant is provided. The method includes receiving input from a job applicant indicative of a self-assessment of attributes of the job applicant. Input may also be received from a person familiar with the applicant which is indicative of an assessment of attributes of the applicant. Based on the received assessments, a rating of the applicant is then created. An employer may provide a desired rating for attributes for the job position. The desired rating and the rating are compared to each other, and if the applicant rating meets or exceeds the desired rating, the applicant is identified as a match to the job position.

In yet another embodiment, a system for creating an online employment profile of a job applicant in a job type is provided. The system may include means for accessing a database to retrieve applicable attributes for the job type. The system may further include means for presenting the retrieved attributes for self-assessment by the applicant and means for receiving a self-rating for each of the retrieved attributes. The system may further comprise means for receiving information identifying one or more survey recipients, the information including an e-mail address for each of the one or more survey recipients. The system may also include means for sending a message to the survey recipients. The message may seek a rating of the applicant in the applicable attributes. The system may also have means for receiving one or more ratings of the job applicant in the applicable attributes in response to the e-mail, and means for storing the received one or more ratings and the self-rating in a employer accessible database.

In still another embodiment, a system for defining a job listing in a computer network includes means for receiving a selection of one of a job type and means for accessing a database to retrieve abilities, skills and knowledge for the selected job type. The system also may include means for presenting user selectable options for specifying whether each of the retrieved attributes are required or optional and means for receiving input specifying required attributes and optional attributes. The system may also provide means for receiving input indicative of a minimal desirable rating.

### BRIEF DESCRIPTION OF THE DRAWINGS

In this description, reference is made to the drawings wherein like parts are designated with like numerals throughout.

FIG. 1 is a block diagram of a network environment suitable for implementing various aspects of the invention.

FIGS. 2A and 2B are block diagrams of types of data that may be stored in the database shown in FIG. 1.

FIG. 3 is a block diagram of various modules that may be included in the server shown in FIG. 1.

FIGS. 4A-4E provide an example of a user interface that may be used by an employer to create and post a job.

FIGS. 5A-5D provide an example of a user interface that may be used by a job applicant to complete a skills survey including a self-assessment.

FIG. 6 provides an illustration of a user interface that may be used by a job applicant to perform a gap analysis.

FIG. 7 provides an example of a job listing management interface.

FIG. 8 provides an illustration of how job matches may be shown on a display.

FIG. 9 is a flowchart of a process for matching job applicants to employers.

FIG. 10 is a flowchart of a process for creating and/or defining an employment profile for a job applicant.

FIG. 11 is a flowchart of a process for defining a job listing.

### DETAILED DESCRIPTION OF THE CERTAIN EMBODIMENTS

Certain embodiments provide for an applicant and talent management system. The system may, in some embodiments, facilitate the process of matching job applicants with employers. The system may be configured to allow a job applicant to self-assess his job attributes in areas identified by employers as being relevant, important, or even critical to the job to which the job applicant applies. Job applicants may also provide more general self-assessments in job attributes relevant to job families and job types. These more general self-assessments may be completed independently of any particular employment opportunity. The job applicant may also provide a list of survey recipients. The survey recipients may be contacted via some communication medium such as an e-mail, for example, and asked to provide an assessment of the applicant's job attributes. A rating of the job applicant may be created based on the assessments made my survey recipients and/or the self-assessment. The ratings may be used to match the employee to job positions offered by employers.

The systems and methods described herein may be implemented in a general purpose computing environment. In one illustrative embodiment, various general purpose computing devices such as personal computers may be used to implement and run software configured to perform the methods described herein. Specialized computing devices such as computer network appliances may also be used. Other types of computing devices may also provide platforms on which the system may be run. The system may be implemented in a networked computing environment. In some embodiments a wide area network such as the Internet may be utilized to communicate information between computing devices. The system may be implemented as a client/server application, web-based application accessible through browsing software, or it may be implemented utilizing some other computer medium.

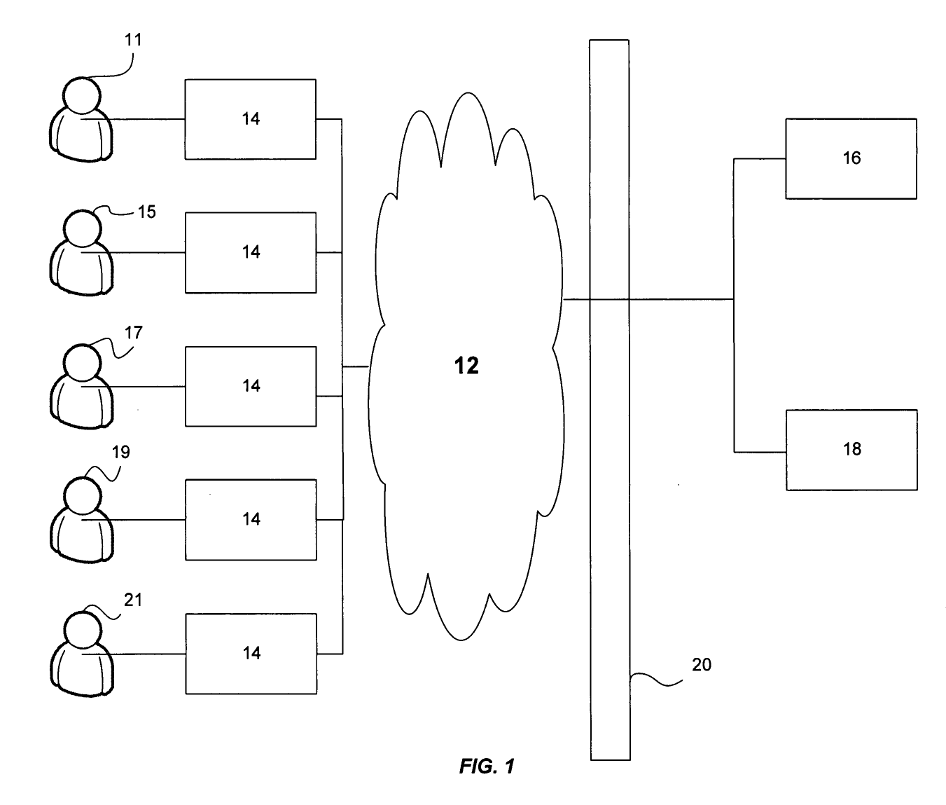

Referring now to FIG. 1, an example of one exemplary configuration of an applicant and talent management system 10 is provided. The applicant and talent management system 10 may include one or more servers 16. In some embodiments, the servers 16 may be web servers configured to host various websites and various web applications. The servers 16 may be in communication with one or more databases 18 which store data that is used by the servers 16 to run the server applications. The databases 18 may be stored on the same hardware as the servers 16, or they may reside on a separate computing device. The applicant and talent management system 10 may be in communication with a network 12 via some type of network connection interface. In some embodiments, the network 12 is a wide area network such as the Internet, for example. The servers 16 and databases 18 may be shielded from a network 12 by a firewall 20. The firewall 20 may be configured to protect the servers 16 and the database 18 from unauthorized network traffic and access attempts. In some embodiments, the servers 16 may be placed “in front” of the firewall 20, while the database 18 may remain “behind” the firewall 20 to protect sensitive data. The firewall 20 may be configured to allow appropriate traffic in a manner well-known in the art.

Connected to the wide area network 12 may be one or more client computing devices 14 which access the Internet via a network connection. The client computing devices 14 may take various forms including, but not limited to, general purpose computers running web browsing software, notebook computers, tablet computers, personal digital assistants, cellular telephones, other handheld devices, or some other computing device capable of accessing the network 12 through a defined application programming interface. The client computing devices 14 may be operated by various users to access modules within the applicant and talent management system 10. For example, one or more client computing devices may be operated by an employer 11 who wishes to post a job listing or review an employee's performance within the applicant and talent management system 10. Also accessing the system 10 may be job applicants 15 who wish to utilize the system 10 to find employment opportunities. The system 10 may be further accessed by mentors 17 who work with job applicants 15 to help them find job opportunities. In addition, survey recipients 19 may also access the system 10 to provide additional information about job applicants 15. A system administrator 21 may also utilize the system 10 to provide, among other things, technical support to the various user groups. Although FIG. 1 describes a particular architecture and configuration for implementation, one of skill in the art will readily appreciate that the applicant and talent management system 10 described is but one of many possible configurations that may be utilized without departing from the scope of the invention.

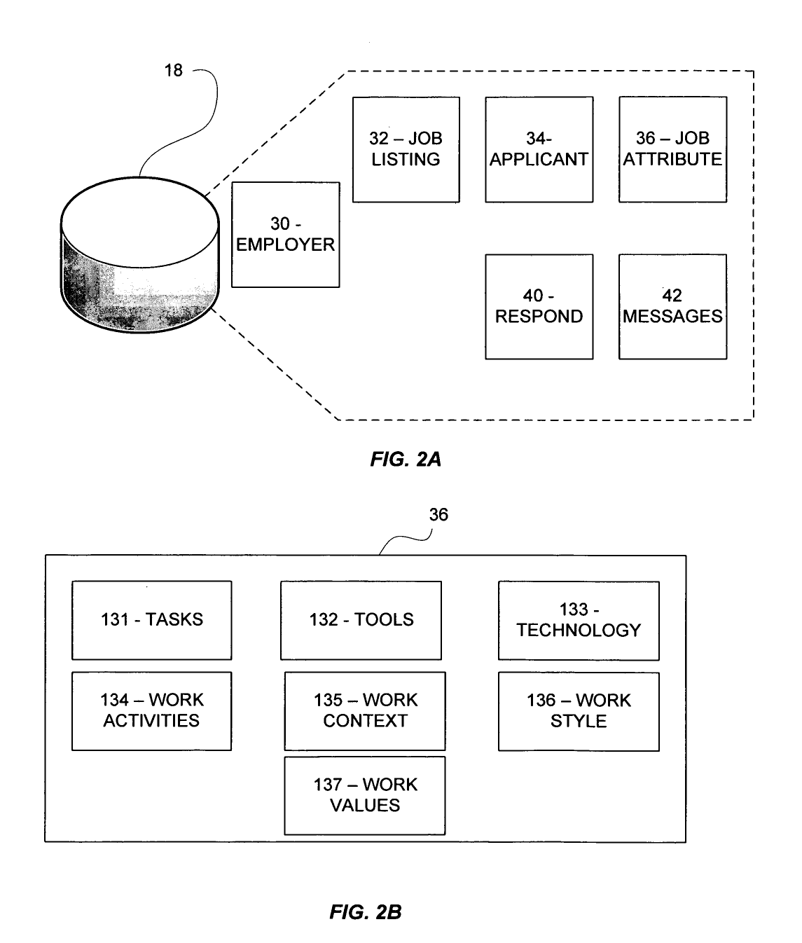

FIG. 2A provides a more detailed view of the database 18. The database 18 may include various types of data which may be structured in various configurations. In one embodiment, the database 18 may include employer data 30. The employer data 30 may include information about employers 11 who post job listings on the system 10. The information stored as employer data 30 may include demographic information about the employer such as a name, address, phone number, website, etc. The employer data 30 may also include information related to the employer's user account such as a user name, password, credit card information for billing purposes, and the like. The employer data 30 may also'include an employer profile that may be displayed to job applicants to provide additional information about the company.

The database 18 may also store job listing data 32 which includes information related to job opportunities posted in the system by employers 11. Job listing data 32 may include a one or more database tables which store job listings. Each job listing may include information about the organization creating the job listing, such as, for example, information which may identify the employer 15 creating the job listing in the system 10. Job listings may also include a job title and a job description which may describe the employment related duties associated with the job listing. The job listing may also include data relating to requirements for minimum years of experience and minimum education level.

In some embodiments, the job listings included in the job listing data 32 may be associated with job types. Job types provide a specific description of the field which is applicable to a particular job listing. In certain embodiments, job types may be associated with job families. Job families may be a broader-based definition of the type of work that may be performed in relation to the job listing. A job family may provide a first broad level (e.g. “Architecture & Engineering”) which allows job applicants 15 to begin narrowing their searches within the system 10.

In some embodiments, job listings may be defined to require that those applying for job listings be from certain localities. For example, a job listing may include data specifying cities, states, area codes, and/or zip codes from which applications may be received. A job listing may also include keywords that may be related to the job being described. These keywords may be used to search through job applicant portfolios to locate candidates having desirable work experience.

The database 18 may further include applicant data 34. Applicant data includes information about job applicants 15 who utilize the system 10 such as their names, addresses, e-mail address, personal websites, etc. Applicant data may further include data related to a job applicant's 15 ability to access the system such as a username and a password. Applicant data 34 may further include personal and professional information such as a resume, a work history profile and the like. In addition, applicant data 34 may include personality traits of the applicant 15 and self-assessment data provided by the applicant 15. Applicant data 34 may also include data related to survey responses provided by the applicant which are related to job attributes of the applicant. The applicant data 34 may further include survey responses provided by those associated with the job applicant such as survey recipients 19. Applicant data 34 may also include an applicant status within the system such as “Active” or “Inactive” or some other status.

Applicant data 34 may also include a list of associates provided by the applicant 15 as persons who may become survey recipients 19. In addition, if an applicant 15 is ultimately hired by an employer 11, their data may remain in the system 10 as employee data.

The database 18 may further include job attribute data 36. Job listings may also be associated with job attribute data 36. The employer 11 entering the job listing may select from various abilities, skills, and/or knowledge included in the job attribute data 36 to specify certain requirements or desirable attributes of job applicants pursuing jobs offered by employers 11. In one embodiment, the attributes may be defined by O-Net, the Occupational Information Network, which is a comprehensive database of worker attributes and job characteristics. Alternatively, some other occupation-related dataset may be used. In still other embodiments, the job attribute data 36 may be defined independently of any external dataset. The job attribute data 36 may include information related the types of abilities, skills, and/or knowledge or other tasks and work experience that may be relevant for a particular job family or job type.

Job attribute data 36 may include general job attribute data and job-specific job attribute data. For example, certain types of abilities, skills, and knowledge may be useful data to have for all job applicants. Data related to a job applicant's motivation and work ethic will be likely to be relevant information for any type of job position and thus be considered general job attribute data. On the other hand, other job attribute data 36 may only be relevant to performance of jobs requiring certain skills. For example, computer programming ability may not be relevant to a job in industrial sales. Similarly, engineering skills may not be relevant to an administrative position.

In some embodiments, job attribute data 36 may be further classified based on how it relates to a given job position. FIG. 2B is a block diagram showing how the job attribute data 36 may be classified. The job attribute data 36 may include data classified as tasks 131. Tasks 131 may relate to specific things that an employee may be asked to do in relation to a type of job listing. Thus, for a job listing for a computer programmer, the listed tasks 131 may relate to specific tasks that will be required to successfully perform as a computer programmer.

Job attribute data 36 may be further classified as tools data 132 and technology data 133. The tools data 132 relates to tools that may be used in a particular job type. For example, for a computer programmer job position, a set of tools may include computer servers, desktop computers, and mainframe computers. Technology data 133 may relate to types of technology that are commonly used in relation to the job position. Technologies such as analytical or scientific software, application server software, compiler software, and the like may constitute job attribute data 36 which may be classified as technology data. Job attribute data 36 may further be classified based on various types of work activities 134 related to the type of job to which the job attribute data 36 is related. By way of an example, for a computer programming job, relevant work activities may include interacting with computers, solving problems, getting information, and the like.

Another type of job attribute data 36 that may be stored in the database 18 is work context data 135. Work context data 135 may include data related to the work environment of a particular job type. Examples of work context data may be time pressure, leadership opportunities, level of competition, and the like. job attribute data 36 may also include work style data 136. Work style data 136 may generally relate to the work traits that may be important to a job type. Examples of work styles may include analytical thinking, attention to detail, dependability, initiative, integrity, and other work styles. One additional classification of job attribute data 36 that may be available within system 10 is work values 137. Work values 137 may include achievement, independence support, recognition and other work values.

The database 18 may also store respondent data 40. Respondent data 40 may be data generally related to survey recipients 19 who receive notifications from the system 10 seeking information about the job applicants 15. The respondent data 40 may include contact information for survey recipients 19 such as e-mail address information or other contact information. The respondent data 40 may further include survey responses about job applicants 15 that have been entered into the system by the survey recipients 19. The respondent data 40 may further include data relating to the relationship between the survey recipient 19 and the job applicant 15 such as whether the survey recipient 19 is a family member, co-worker, supervisor, or the like.

The database 18 may also store message data 42. Message data 42 may include messages sent within the system 10. For example, e-mail messages sent from employers 11 to job applicants 15 may be stored as message data 42. Similarly, notification messages sent from the system 10 to any of the employers 11, job applicants 15, mentors 17, and survey recipients 19 may also be stored. In addition, messages sent to survey recipients 19 seeking information about job applicants 15 may also be stored as message data 42. Generally, any communication message sent among parties using the system 10 may be stored by the system 10 as message data 42 and archived for later reference and data analysis.

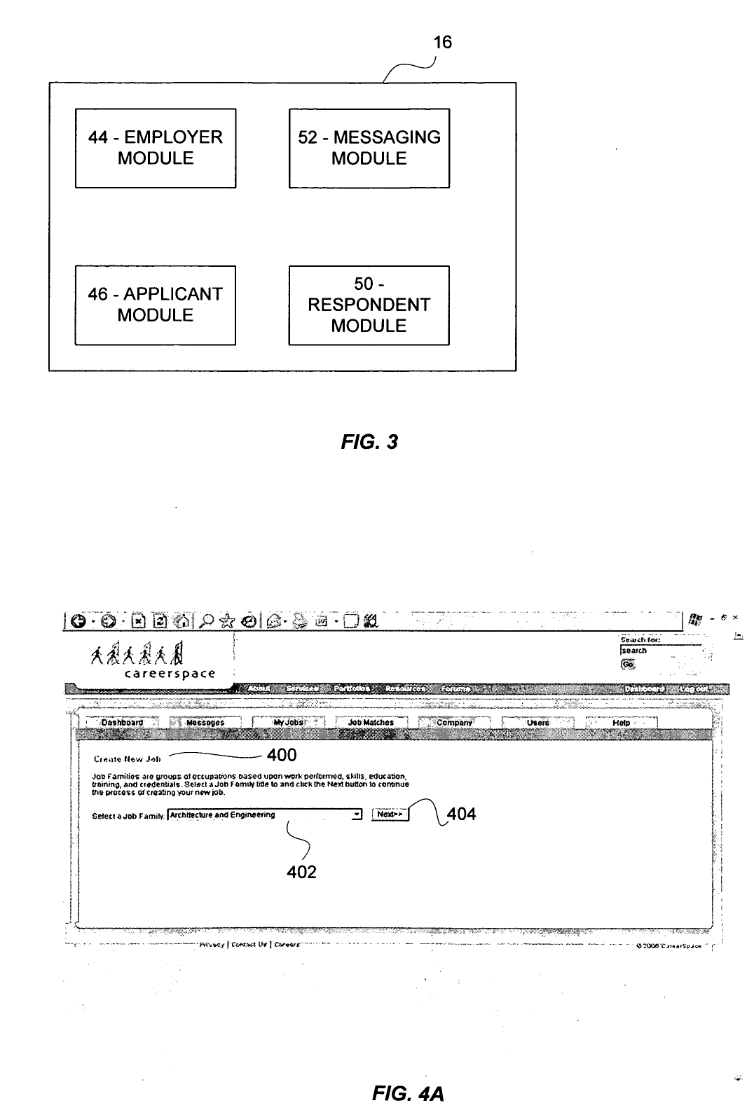

Referring now to FIG. 3, a more detailed view of the servers 16 is provided. The servers 16 may include various modules that provide functionality to users of the system 10. As noted above, the servers 16 will generally run the applications and web server that are accessed by users in order to utilize the various features of the system 10. The server 16 may include an employer module 44. The employer module 44 may include program code that provides employers 11 access to the server 16. The employer module 44 may provide an assortment of functionalities to employers 111 using the system 10 such as the ability to create job listings, view applicant matches to the job listings, and contact job applicants. The employer module 44 may include one or more sub-modules which allow the employer 11 to create an employer profile within the system 10 which may be stored in database 18. The employer profile may be displayed to job applicants to give them more information about the employer 11.

The employer module 44 may also be configured to allow an employer to create new jobs or job descriptions in the system 10. In one embodiment, the employer 11 may be permitted to create as many jobs as they like without cost. The employer module 44 may be configured to store all created jobs in the system permanently, or until removed by the employer 11. In one embodiment, the ability to create and store jobs may be provided at no cost to the employer 11. However, posting or listing the job as an available position for job applicants may cause the employer 11 to incur a charge. The employer module may further include a jobs listing management interface that allows employers 11 to easily sort, modify, and otherwise manage jobs they have created in the system. The employer module may also be configured to display job applicants 15 who are “matches” to job positions posted in the system by the employer 11. The matching functions will be discussed in more detail below. The employer module 44 may also include a messaging interface. The messaging interface may be configured to allow employers 11 to send messages to other users of the system 10, via e-mail, via instant message, or some other messaging means.

The server 16 may also include an applicant module 46. The applicant module 46 runs scripts, functions, and programs related to the functionality provided by the job applicants 15 who access the system 10. The applicant module 46 may further be configured to provide an interface by which job applicants 15 are able to apply for specific jobs listed in the system 10. In addition, the applicant module 46 may include a skills survey interface. The skills survey interface allows the job applicant 15 to provide self-assessment data about his skills in areas related to the job attribute data 36. An applicant may provide a self-assessment of skills for any number of job types. job attribute data 36 relevant to different job types may overlap because certain abilities, skills, and/or knowledge may be relevant to more than one job type. As a result, self-assessment of certain skills related to one job type may be carried over to overlapping skills in other job types. The applicant module 46 may be further configured to provide an assignment sub-module. The assignment sub-module displays tasks and assignments for job applicants 15 to complete. The assignments and tasks may be created by the job applicants 15 or by the system 10. The applicant module 46 may also provide an account management interface. The account management interface may be configured to allow the job applicant to modify passwords, make payments, and make other modifications to the account. The applicant module 46 may also include messaging features similar to those described above in connection with the employer module 44.

The server 16 may also include a survey respondent module 50. The survey respondent module allows survey recipients 19 identified by the job applicants 15 as having knowledge of their skills to access the system and provide assessments. In one embodiment, the survey respondent module 50 may be configured to send an e-mail to survey respondents 50 which includes the survey questions embedded as HTML code in the e-mail. In another embodiment, the e-mail may include an HTML link or some other location identifier which allows the survey respondent to access the system 10 using a web browser and enter their survey responses via a web interface.

The server 16 may further include a messaging module 52. The messaging module 52 may be program commands that provide for the transmission and storage of messages by various users of the system 10. In one embodiment, the messaging module 52 may define an internal message system which provides each user the ability to send messages to other uses in the system 10. In other embodiments, the messaging module 52 may further provide functionality that allows users to send messages outside the system as e-mail messages to non-registered users. The messaging module 52 may also be configured to provide message storage services to system users. In some embodiments, the messaging module may be integrated with an existing e-mail system such that messages passed within the messaging system 52 are sent via a user's e-mail client.

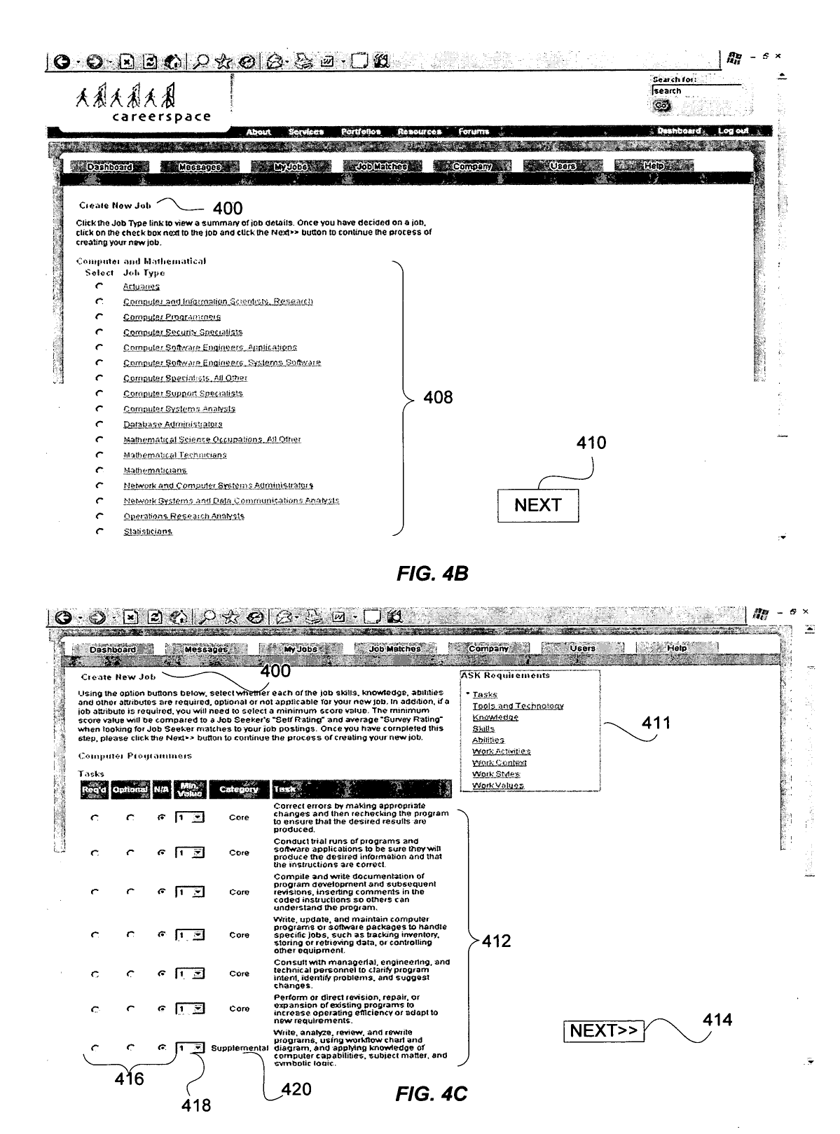

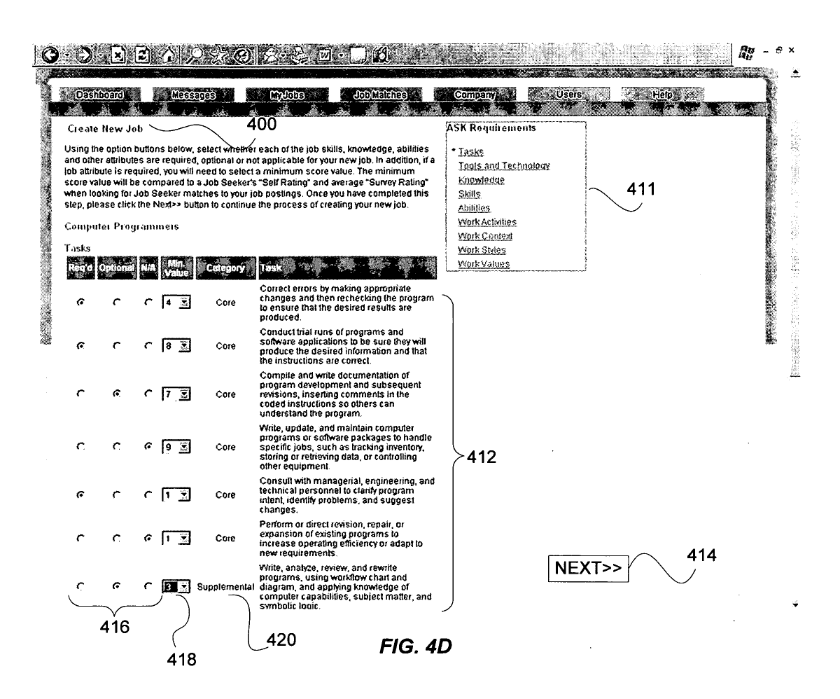

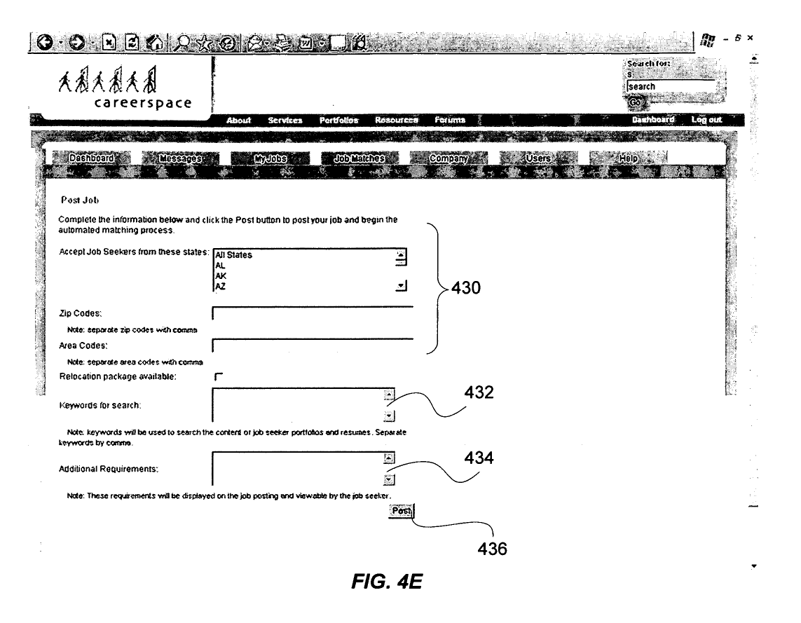

As noted above, certain embodiments provide an applicant and talent management system that allows employers 11 to create and post job opportunities in which they specify certain requirements or desirable attributes of job applicants who pursue the job opportunity. FIGS. 4A-4D provide an illustration of a user interface that may be used by an employer 11 to create a job listing.

Referring now to FIG. 4A, an example of new job creation interface 400 is provided. The new job creation interface may include one or more web pages that allow the employers 11 to define and activate a new job posting within the system 10. When defining a new job, the employer 11 may first choose a job family 402. In the embodiment shown the job families are presented in a drop down box 402 that allows for easy selection. The job families may be stored in the database 18. Once the employer 11 has selected the desired job family, the “Next” button 404 may be selected to advance to the next page in the job creation interface 400.

FIG. 4B provides an example of a job type selection list 408. Based on the job family selected in FIG. 4A, the system 10 queries the database 18 to determine which job types are relevant to the selected job family. The selected job types are displayed to the user for selection. In the embodiment shown in FIG. 4B, the job types are listed in a radio button interface, but any other suitable selection interface element may be used (such as a dropdown list or checkboxes, for example). In some embodiments, each job type listed in the job type selection list 408 may be a hyperlink that leads to a webpage that provides additional information about the job type. In order to proceed to the next step in creating a new job, the employer 11 may select their desired job type from the job type selection list 408 and then click on the “Next” button 410.

After selecting the desired job type, the employer 11 may then proceed to specify the job attribute data 36 that is relevant to the new job position. In some embodiments, based on the job type selected by the employer in FIG. 4B, the system 10 may be configured to query the database 18 to select the appropriate job attribute data 36 to display to the employer 11. The job attribute data 36 may include both job-specific job attribute data or general job attribute data. FIG. 4C provides one example of a user interface that may be used to determine how the selected job attribute data 36 is relevant to the job position. As noted above, the job attribute data 36 may be broken down into different types of classifications. Some or all of the classifications may be displayed in a display element 411. The listed job attribute data 36 classifications may be hyperlinks that allow the user to navigate to desired job attribute data attributes 36 more quickly.

The job attribute data 36 selected by the system may be displayed in a list of job attributes or requirements. Each requirement may include a category 420 and a description 412. Each job requirement may be categorized as being a core requirement or a supplemental requirement. Core requirements may be those abilities, skills, knowledge, and other job attributes that are especially relevant to the selected job type. The supplemental requirements may be less relevant to the job type. For each job-related requirement listed, the employer 11 may make a selection to designate whether the selected job requirement is required, optional, or not applicable to the job position that is being created. In the embodiment shown, the selection may be made by selecting the appropriate radio button 416 for each requirement. The default selection may be set to not applicable. This allows the employer to the links in the display element 411 to quickly jump to a targeted job attribute data 36 classification without having to provide a selection for each requirement. If the employer 11 indicates that a particular job requirement is required, he may selected a minimum value 418. The minimum value 418 may be compared to the self-assessments of job applicants 15 and the assessments made by survey recipients 19 about job applicants.

FIG. 4D provides an example of how user interface of FIG. 4C may look after the employer 11 has selected the job attributes for the job position. As shown in the figure, various attributes have been designated as being required, and minimum values 418 have been defined for the attributes. Once the employer 11 has defined the job attributes for the new job position, the job may be saved into the database 18 and associated with the employer's account for later use. Alternatively, the employer 11 may wish to immediately post the job so that job applicants 15 and other system users such as mentors 17 may view the job listing.

FIG. 4E provides an example of a user interface that allows the employer to post a created job position to the system 10. In the embodiment provided, the employer 11 may define certain parameters to be utilized in an automated matching process that will be described in further detail below. For example, the employer 11 may specify geographical areas 430 to limit the eligible job applicants for the position. The employer 11 may also specify keywords 432 for searching job applicant 15 portfolios. The keywords 432 may be compared against the job applicants' profiles to help determine a close match. The employer 11 may also specify additional job requirements 434 which are displayed to job applicants 15 as they view the job position within the system 10. Once the employer 11 has finished defining the job parameters, the employer 11 may select the “Post” button 436 which stores the job in the database 18 and activates it for display in the system 10.

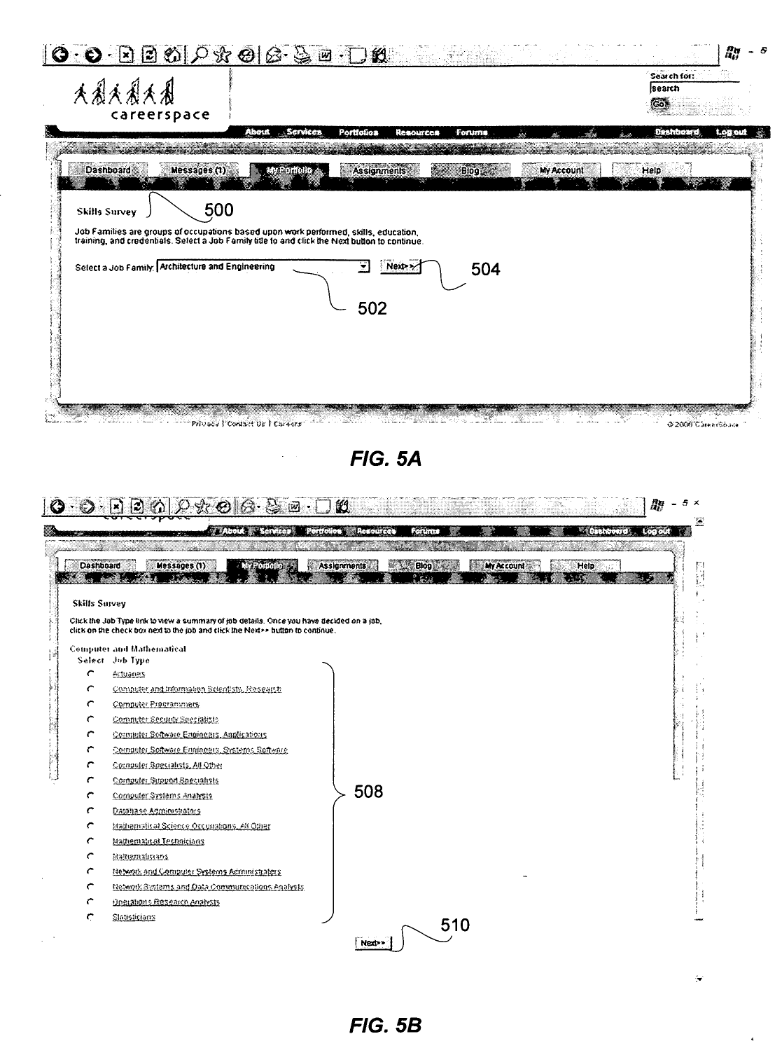

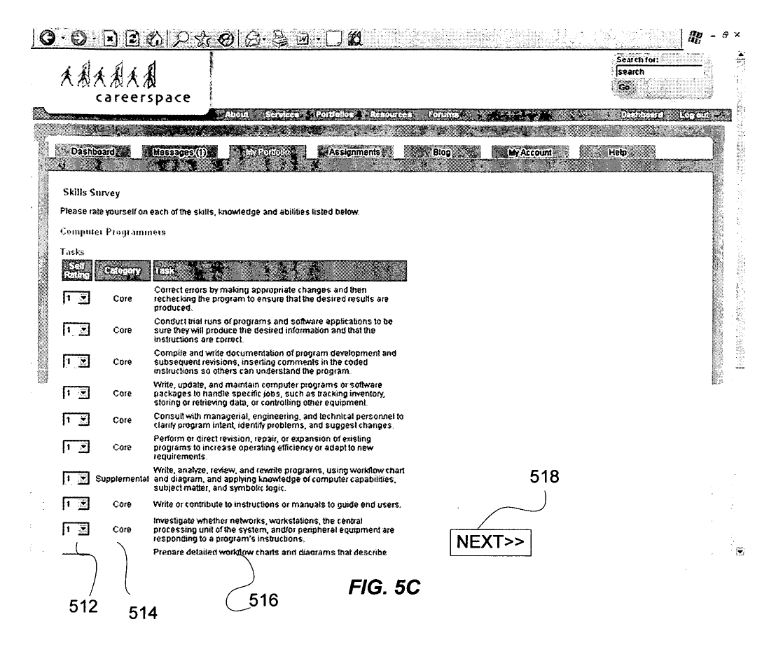

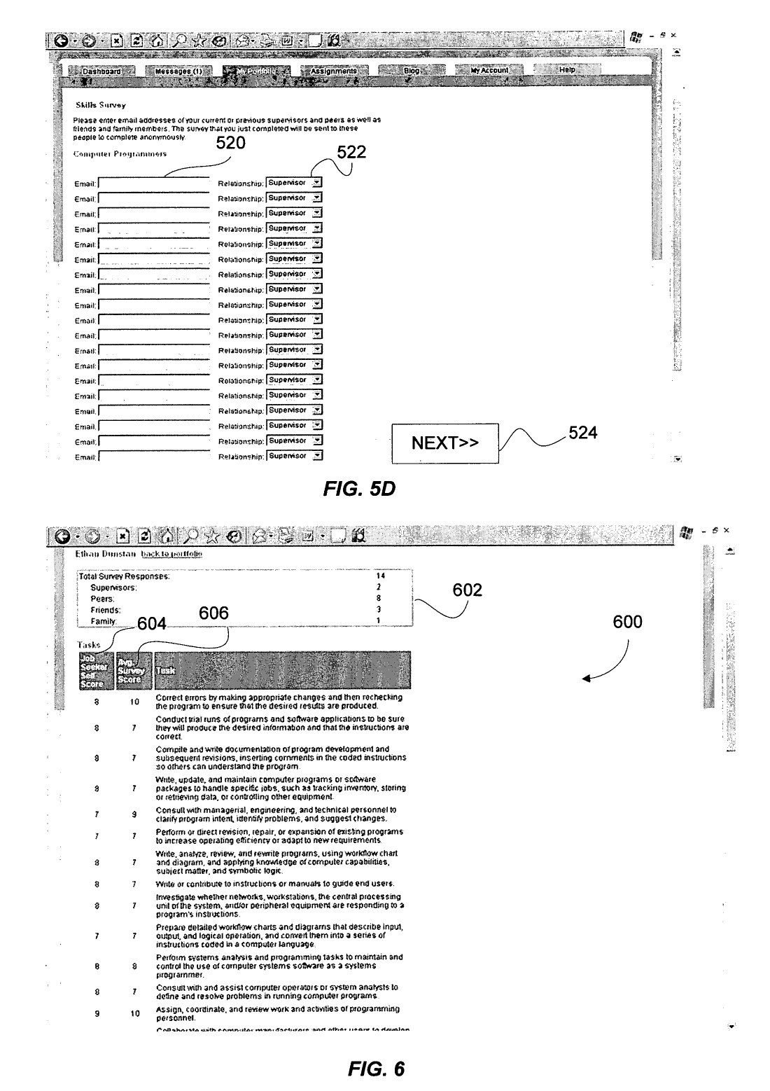

Certain embodiments provide for automated matching of job applicants 15 to employers 11, or more specifically to the job positions posted by the employers 11. FIGS. 5A-5D provide an illustration of how a job applicant 15 may define their candidate profile by completing a skills survey 500 which allows their profile to be compared and possible matched to job positions posted within the system 10 by the employers 11.

With reference to FIG. 5A, an example of a job applicant skills survey 500 is provided. The skills survey 500 utilizes the job attribute data 36 stored in the database 18 to allow the user to provide self-assessments of their abilities, skills, knowledge, and other job attributes related to their desired employment. In beginning the skills survey 500, the job applicant 15 may first select a job family from the dropdown menu 502. The menu options in the dropdown menu 502 may be similar to those provided to employers 11 in FIG. 4A. Once the job applicant has made a selection, the “Next” button 504 may be selected to proceed to the next screen which is shown in FIG. 5B. Once the job family has been selected, the system 10 may query the database 18 to select the job types that are associated with the selected job family. The selected job types may be displayed to the user in a list having selection elements 508 as shown in FIG. 5B.

Once the job applicant 15 has selected a job type, the system 10 may be configured to retrieve the job attribute data 36 that is associated with the selected job type. Once the job attribute data has been selected, a self-assessment interface may be presented to the job applicant 15. With reference to FIG. 5C, an example of a self-assessment interface is provided. The self-assessment interface may include a self-rating dropdown 512 which allows the user to select a numerical rating of their aptitude in the each listed requirement. In some embodiments, the rating may be on a scale of 1-10, but other rating scales may be used, including non-numerical rating systems. As discussed above in connection with FIG. 4C, each requirement 516 may be categorized as being either core or supplemental, although some general job attribute data elements 36 (as opposed to job-specific job attribute data 36) may not be categorized.

Once the job applicant has completed the self-assessment, he may be presented with the option of specifying peers, associates, supervisors, and other persons as survey recipients 19 who receive the same or a substantially similar skills survey to complete on behalf of the job applicant 15. FIG. 5D provides an example of such an interface. The interface may include one or more e-mail fields 520 in which the job applicant may provide an e-mail address for each designated survey recipient 19. Each e-mail field 520 may have an associated relationship selection element 522 which allows the job applicant to provide their relationship to the designated survey recipient. In the example provided, the relationship is selected from a dropdown box. In other embodiments, the user may create new relationships by typing them into another text box. Once the user has specified all of their survey recipients 19, they may click on the “Finish” button 524 causing the system to store the data entered by the job applicant in the database 18. The system 10 may also send an e-mail to each of the specified survey recipients 19 with an invitation to assess the job applicant 15 by utilizing the same survey complete by the job applicant 15.

After the survey recipients 19 have completed their survey responses, the survey responses may be returned to the system 10 for storage in the database 18. The system 10 may be configured to utilize the survey responses in various ways. In one embodiment, the survey responses may be used to provide the job applicant 15 with a gap analysis of the differences between the job applicant's assessment of their own skills as compared to the assessments provided by others. In some embodiments, this data may be provided to the job applicant by a mentor 17 of the job applicant 15, possibly as part of an established mentoring program. Alternatively, this gap analysis may be provided to all job applicants, regardless of whether they are part of a mentoring program.

FIG. 6 provides an example of a gap analysis interface 600 that may be presented to the job applicants 15 to help them develop an understanding of how others perceive their capabilities and work-related attributes. The gap analysis interface 600 may include a listing 602 of total survey responses. The information provided in the listing 602 indicates the total number of survey responses received into the system 10 that are related to the job applicant 15. In the example provided in FIG. 6, the total number of survey responses is further broken down according to the relationship that the survey recipients 19 have with the job applicant 15.

The gap analysis interface 600 may further include a table which shows in a first column 604 the job applicant's self-assessment scores. The table may further include a second column 606 which shows the average score given to the job applicant by the survey recipients 19. In some embodiments, in order to protect the anonymity of the survey recipient's scores, the system 10 may be configured to show only the average scores when a certain number of survey responses have been received from survey recipients 19.

Once the job applicant 15 has entered the assessment data and received input from survey recipients 19, and once the employer 11 has created a new job listing including a specification of the desired scores for job applicants applying for the position, the server 16 may be configured to extract the assessment data and job position data from the database 18. Extracting the assessment data and job position data allows the system to match with the job position those job applicants 15 meeting the attribute requirements specified by the employer 11. Once the system 10 has determined which job applicants meet the job requirements, this information may be provided to the employer 11 so that they may contact the identified applicants to discuss a potential position.

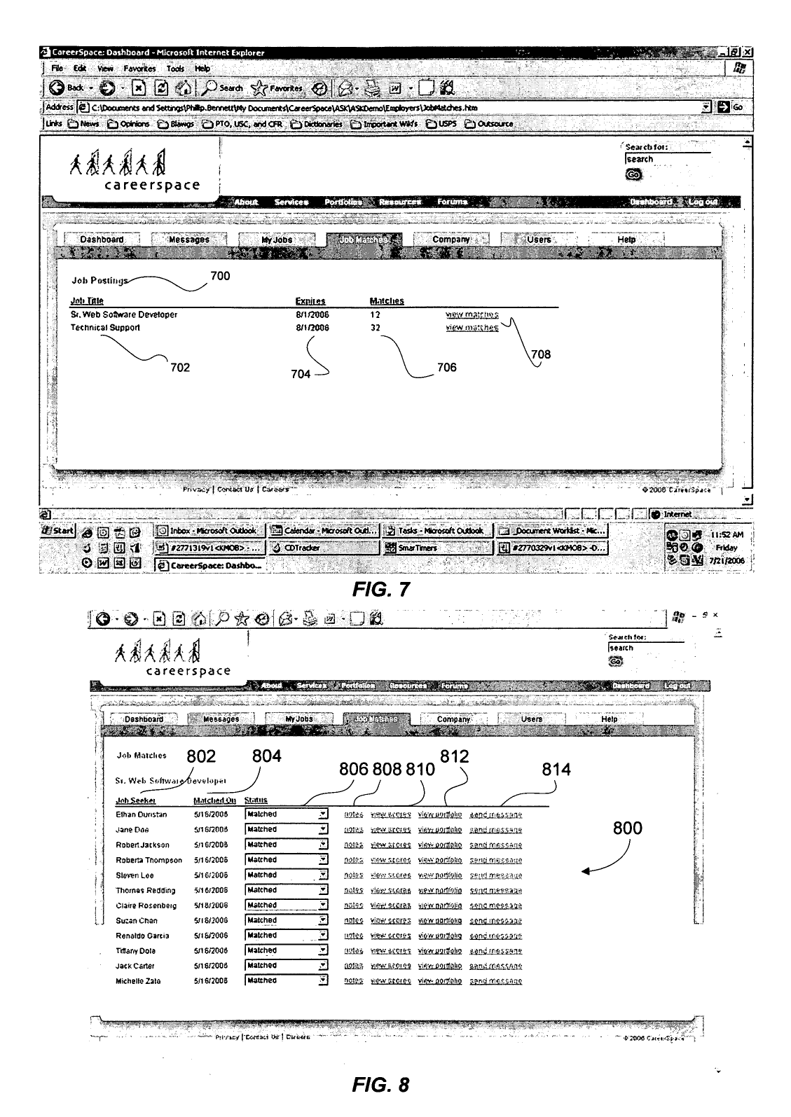

FIG. 7 provides an example of a job postings management menu 700 that allows the employer 11 to view all of their active job postings and the number of matches to job applicants 15 found by the system 10. The menu 700 may include a table having a job title column 702 which may list each job the employer 11 has posted within the system. The table may further include a job expiration column 704 which provides information indicating the expiration date of each job listed in the menu 700. The menu 700 may also include a matches column 706. The matches column 706 may provide the number of job applicants 15 located by the system 10 that match the criteria specified by the employer 11 when creating each job. In the example provided in FIG. 7, the job entitled “Sr. Web Software Developer” expires on Aug. 1, 2006, and has 12 matching job applicants that have been identified by the system. Once the employer 11 is alerted to the fact that there are matching job applicants 15 for the posted job position, the employer 11 may wish to view further details about the job applicants 15. The menu 700 provided in FIG. 7 may further provide a “View Matches” link 708 which, when selected by the employer 11, opens a job matches menu 800, an example of which is shown in FIG. 8.

The job matches menu 800 generally displays information about those job applicants 15 satisfying the criteria defined by the employer 11 for a job position. Although the information may be displayed utilizing various types of display elements, in the example provided in FIG. 8, the information is presented in a table format. The table may include a job seeker column 802 which provides the employer 11 with the names of each job applicant 15 matched by the system 10. The table may further include a column 804 indicating the date that the job applicant 15 matched to the job position. In addition, a status column 806 may be provided to indicate whether and how the employer 11 has interacted with each matching job applicant 15.

The table may further include various hyperlinks that allow the employer 11 to further develop information about each matching job applicant 15. For example, the table may include a notes link 808 which when activated by the employer 11, sends the employer to a text entry for writing and storing notes about the job applicant 15. The menu 800 may further provide for a view scores link 810 which allows the employer 11 to view detailed information about the job applicant's self-assessment and survey recipient assessments. If the employer wishes to view a resume and other material about the job applicant 15 listed in the job matches menu 800, they may click on the view portfolio link 812. The view portfolio link 812 allows the employer 11 to access job applicant's 15 entire public profile, including but not limited to an online resume, a blog, and other information about the job applicant 15. Lastly, if the employer 11 wishes to communicate with a matching job applicant (e.g., to set up a job interview), the employer may click on the send message link 814 which opens a page for sending a message to the job applicant using the messaging module 52.

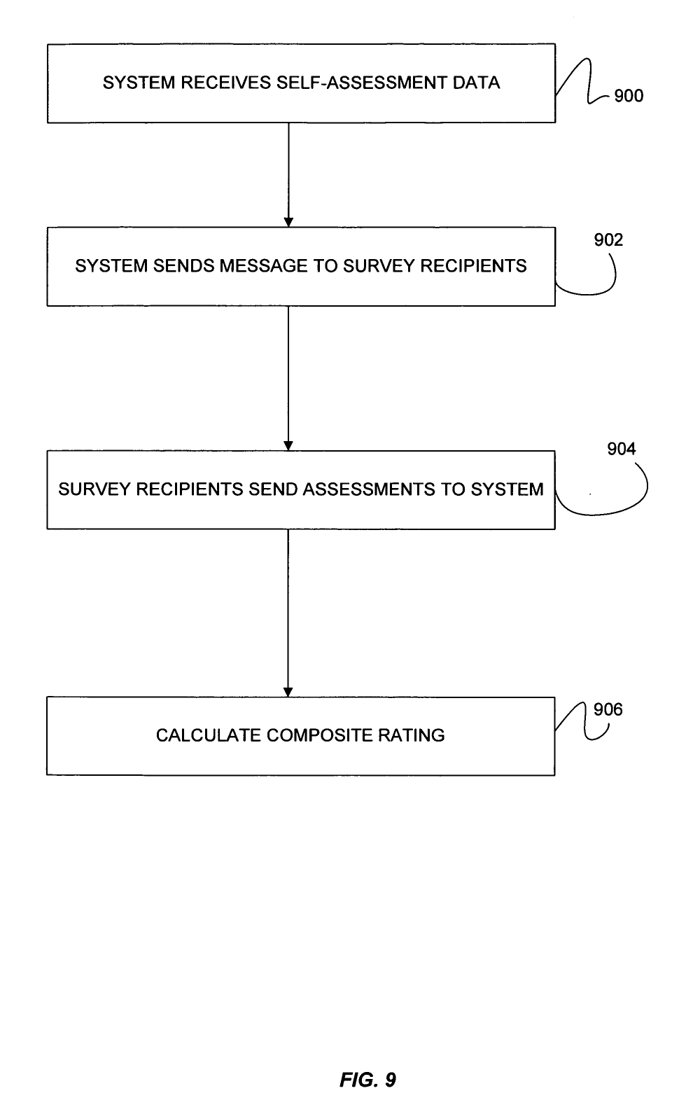

As noted previously, aspects of the present invention provide for systems and methods for matching job applicants to employers. FIG. 9 is a flowchart illustrating such a method according to one embodiment. At block 900, the system 10 receives a self-assessment from the job applicant 15 of their aptitude in certain abilities, skills, knowledge, and other job attributes. At block 902, the system 10 sends a message to survey recipients which requests that they evaluate the job applicant in the same or substantially similar abilities, skills, knowledge and other job attributes. Next, at block 904, the survey recipients 19 send their assessments of the job applicant 15 to the system and the system receives that information. Next, at block 906, the system determines a rating for the job applicant in the certain abilities, skills, knowledge and other job attributes. Based on that rating, the system then matches the job applicant 15 to employers 11 having job positions suitable to the job applicant's rating.

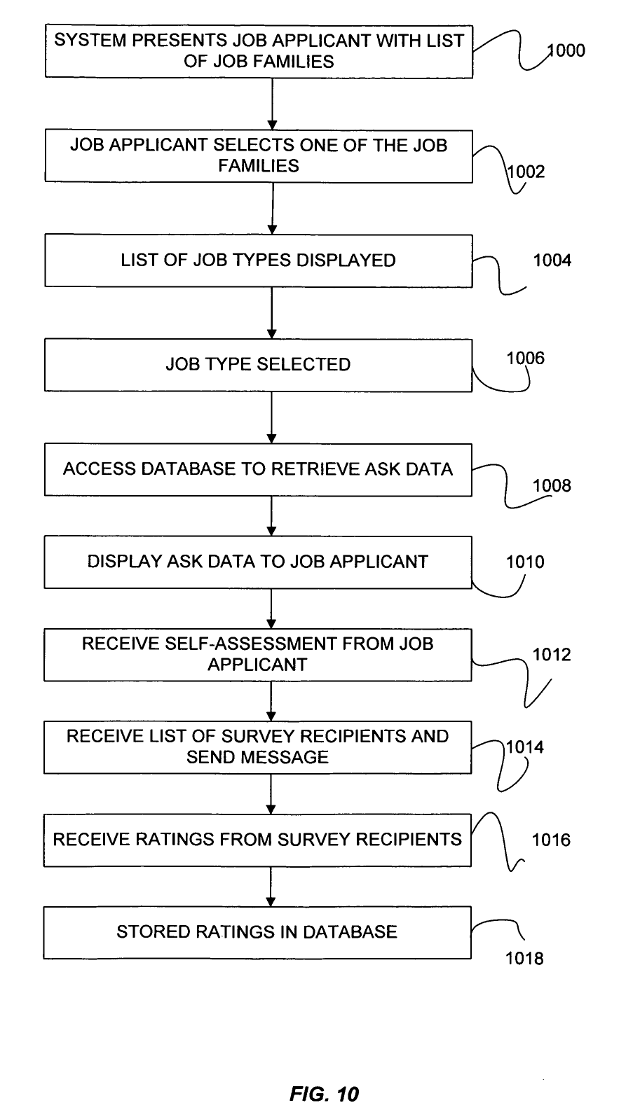

In another embodiment, the system may be configured to create or define an employment profile for job applicants 15 who utilize the system 10. FIG. 10 is a flowchart describing such a process. The process begins at block 1000 where the system 10 presents a job applicant 15 with a list of job families. Next, at block 1002, the job applicant selects one of the jobs from the lists. Based on the selected job family, a list of job types may be presented to the user at block 1004. Next, at block 1006, the system may receive a selection of one of the job types. Next, at block 1008, the system 10 may access the database 18 to access job attribute data 36 for the selected job type. Once the job attribute data 36 has been retrieved from the database 18, the job applicant is presented with the job attribute data 36 for self-assessment at block 1010. The applicant 15 provides self-assessment and send the self-ratings back to the system 10 at block 1012, and then provides a list of survey recipients 19 at block 1014. After receiving the list of survey recipients 19 from the applicant 15, the system 10 then sends a message to the survey recipients 19 requesting that they rate the applicant 15 in the job attribute data 36. At block 1016, the system receives one or more ratings of the job applicant 15 from the survey recipients 19 in the job attribute data 36. The process then concludes at block 1018 where the system stores the received data in the database 18.

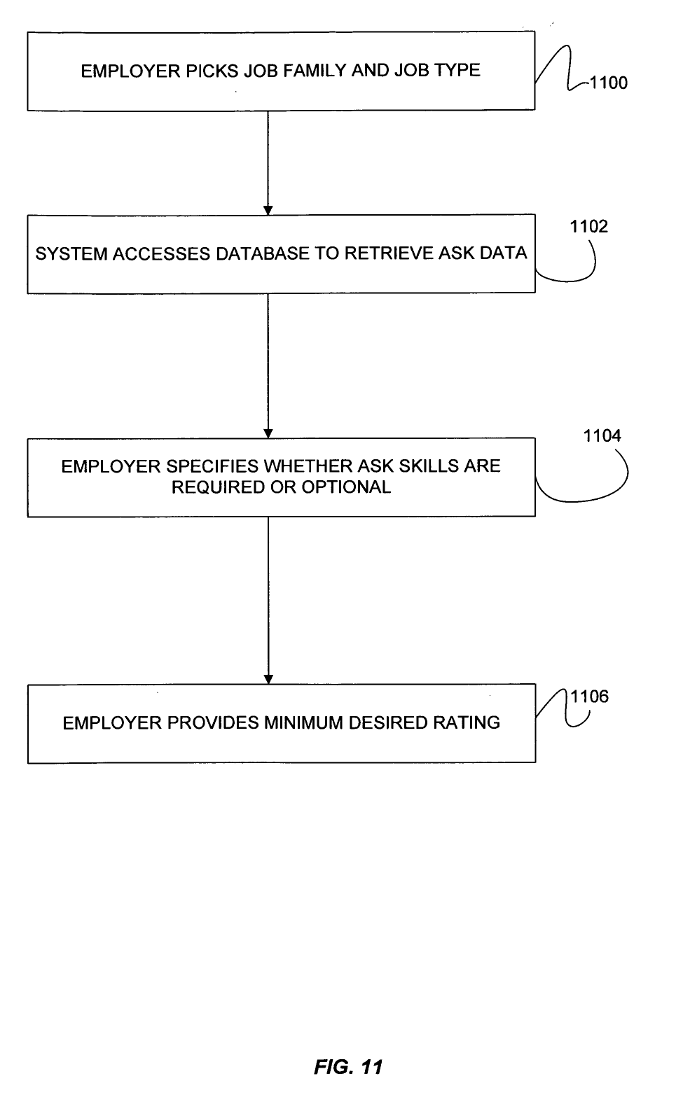

In yet another embodiment, the system 10 is configured to implement a process which defines a job listing in a computer network as shown in FIG. 11. The process begins at block 1100 where the employer picks a job family and job type. Next at block 1102, the system 10 accesses the database 18 to retrieve abilities, skills, and knowledge related to the job type selected by the employer 11. Next at block 1104, the employer specifies whether each of the abilities, skills, and knowledge is optional or required. Finally, at block 1106, for each required ability, skill, or knowledge, the employer 11 provides a minimum acceptable or desirable rating.

It will be understood by those of skill in the art that numerous and various modifications can be made without departing from the spirit of the present invention. For example, in one alternative embodiment, the applicant and talent management system may be configured to operate as a plug-in or add-on application to internal human resources applications within an organization in order to facilitate professional development opportunities within the organization. Surveys may be sent to co-workers and/or supervisors seeking assessment of employees within the organization. The assessments may be provided to employees to give them a “surround-view” analysis of their abilities, skills, knowledge, and other job attributes and work characteristics. The assessment information may allow employees to better understand their strengths and weaknesses (as perceived by others), which can help them further develop their career plan. In addition, the aggregate data collected by the applicant and talent management system may be used to identify overall strengths and weaknesses within an organization. Based on these strengths and weaknesses, training programs may be designed and aligned to organizational objectives and workforce development.

In still other embodiments, the applicant and talent management system may be configured to provide performance appraisal services within an organization. For example, a supervisor and supervisee may set agreed upon performance goals in various job attributes by specifying performance levels in certain job attributes. Surveys may completed by supervisors and/or coworkers which allow supervisors and supervisees to pinpoint areas of strength and weakness. Moreover, the assessments provided may be used to identify commendable performances and alert employers and supervisors to those not meeting the agreed upon goals.

In view of these and other alternate embodiments, it should be clearly understood that the forms of the invention are illustrative only and are not intended to limit the scope of the invention.

What is claimed is:

1. A computer-implemented method of creating an online employment profile for an applicant, the method comprising:
accessing a database to retrieve applicable attributes for a job type;
presenting the retrieved attributes for self-assessment by the applicant;
receiving a self-rating for each of the retrieved attributes;
receiving information identifying one or more survey recipients, the information including contact information for each of the one or more survey recipients;
sending a message to the survey recipients, the message seeking a rating of attributes of the applicant;
receiving, in response to the message, one or more ratings of the attributes of the applicant; and
storing the received one or more ratings and the self-rating in an employer accessible database.

2. The method of claim 1, further comprising:
presenting for selection by the applicant a plurality of job families; and
receiving a selection of one of the plurality of job families.

3. The method of claim 2, further comprising:
presenting, based on the selected job family, a plurality of job types for selection by the job applicant; and
receiving a selection of one of the job types.

4. The method of claim 1, wherein the information identifying one or more survey recipients further includes an indication of a relationship between each of the one or more survey recipients and the applicant.

5. The method of claim 4, wherein the relationship is a supervisory relationship.

6. The method of claim 4, wherein the relationship is a familial relationship.

7. The method of claim 1, wherein the attributes comprise abilities.

8. The method of claim 1, wherein the attributes comprise skills.

9. The method of claim 1, wherein the attributes comprise knowledge.

10. The method of claim 1, wherein the attributes comprise work values.

11. The method of claim 1, wherein the attributes comprise work context.

12. The method of claim 1, wherein the one or more ratings are numerical ratings.

13. The method of claim 1, wherein the message is an e-mail message.

14. A computer-implemented method for matching a job applicant with an employer, the method comprising:
receiving input data from the job applicant, the input data including a self-assessment by the job applicant of the aptitude of the job applicant in job attributes;
sending a message to persons knowing the job applicant, requesting assessment of the job applicant in at least one of the job attributes;
receiving, from the persons knowing the job applicant, data indicative of an assessment of the at least one of the job attributes of the job applicant;
creating, based on the data received from the persons knowing the job applicant, a rating for the job applicant in the job attributes; and
matching, based on the rating, the job applicant to the employer.

15. The computer-implemented method of claim 14, further comprising:
receiving, from the employer, data indicative of minimum acceptable ratings for applicants to be matched with the employer.

16. The method of claim 14, wherein the input data from the job applicant further includes persons knowing the applicant.

17. The method of claim 16, wherein the information identifying one or more one or more persons knowing the applicant further includes an indication of a relationship between each of the one or more survey recipients and the applicant.

18. The method of claim 17, wherein the relationship is a supervisory relationship.

19. The method of claim 17, wherein the relationship is a familial relationship.

20. The method of claim 14, wherein the attributes comprise work values.

21. The method of claim 14, wherein the attributes comprise work context.

22. The method of claim 14, wherein the composite rating is a numerical rating.

23. The method of claim 14, wherein the message is an e-mail message.

24. A computer-implemented method of defining a job listing in a computer network, the method comprising:
receiving a selection of a job type;
accessing a database to retrieve attributes for the selected job type;
presenting user selectable options for specifying whether the retrieved attributes are required or optional;
receiving input specifying required attributes and optional attributes; and
receiving input indicative of a minimal desirable rating for the required attributes.

25. A computer-implemented method of matching an employer offering a job position and a job applicant, the method comprising:
receiving input from a job applicant indicative of a self-assessment of attributes of the job applicant;
receiving input from a person familiar with the applicant indicative of an assessment of attributes of the applicant;
creating a rating of the applicant based on the self-assessment and based on the assessment;
receiving input from an employer indicative of a desired rating of attributes for the job position;
comparing the desired rating to the rating; and
identifying the applicant as a match to the job position if the rating meets or exceeds the desired rating.

26. The computer-implemented method of claim 25, further comprising presenting the identified matched applicant to the employer.

27. A system for creating an online employment profile of a job applicant in a job type, the system comprising:
means for accessing a database to retrieve applicable attributes for the job type;
means for presenting the retrieved attributes for self-assessment by the applicant;
means for receiving a self-rating for each of the retrieved attributes;
means for receiving information identifying one or more survey recipients, the information including an e-mail address for each of the one or more survey recipients;
means for sending a message to the survey recipients, the message seeking a rating of the applicant in the applicable attributes;
means for receiving one or more ratings of the job applicant in the applicable attributes in response to the e-mail; and
means for storing the received one or more ratings and the self-rating in a employer accessible database.

28. A system for defining a job listing in a computer network, the system comprising:
means for receiving a selection of a job type;
means for accessing a database to retrieve attributes for the selected job type;
means for presenting user selectable options for specifying whether each of the retrieved attributes are required or optional;
means for receiving input specifying required attributes and optional attributes; and
means for receiving, for each of the required attributes, input indicative of a minimal desirable rating.

29. A computer-assisted method of identifying gaps between employee talent and employer requirements, the method comprising:
accessing a database to retrieve applicable attributes for a job type of the employee;
presenting the retrieved attributes for self-assessment by the employee;
receiving a self-assessment of the employee in one or more of the retrieved attributes;
receiving information identifying one or more survey recipients, the information including contact information for each of the one or more survey recipients;
sending a message to the survey recipients, the message seeking a rating of attributes of the employee;
receiving, in response to the message, one or more ratings of the employee in the attributes; and
storing the received one or more ratings and the self-assessment in an employer accessible database.

30. A computer-assisted method of setting performance expectations between a supervisor and a subordinate, the method comprising:
accessing a database to retrieve applicable attributes for a job type of the subordinate;
receiving specified performance goals in the received attributes;
presenting the retrieved attributes for rating of the subordinate by the supervisor;
receiving one or more ratings of the attributes of the subordinate from the supervisor;
receiving information identifying one or more survey recipients, the information including contact information for each of the one or more survey recipients;
sending a message to the survey recipients, the message seeking a rating of attributes of the employee;
receiving, in response to the message, one or more ratings of the attributes of the employee; and
comparing the ratings of the supervisor and survey recipient to the performance goals; and
determining a performance assessment based on the comparing.
